(19) United States
(12) Patent Application Publication
(10) Pub. No.: US 2006/0122855 A1
(43) Pub. Date: Jun. 8, 2006

(54) Identifying and locating eligible WIC items in a store

(75) Inventor: Thomas J. Prorock, Raleigh, NC (US)

Correspondence Address: KELLY K. KORDZIK;WINSTEAD SECHREST & MINICK PC, PO BOX 50784, DALLAS, TX, 75201, US

(73) Assignee: International Business Machines Corporation, Armonk, NY (US)

(21) Appl. No.: 11/005,001

(22) Filed: Dec. 6, 2004

(51) Int. Cl. G06Q 99/00; G06Q 30/00; G06Q 50/00

(52) U.S. Cl. 705/1; 705/15

(57) ABSTRACT

A method, computer program product and system for identifying and locating items, e.g., eligible WIC items, in a store. A shopping device, such as one located on a shopping cart, may obtain a WIC participant's personalized food package that was stored on a smart card provided to the WIC participant. The shopping device may display the eligible WIC items in the WIC participant's personalized food package in terms of the layout of the store. The shopping device may be configured to guide the WIC participant, such as through arrows or word commands displayed on the shopping device, to the eligible WIC items. The shopping device may also be configured to display at the end of the shopping session those WIC eligible items that were not purchased. In this manner, a system that implements the WIC-EBT standard while also assisting the WIC participant in locating their WIC eligible items is provided.

### TECHNICAL FIELD

The present invention relates to the field of product locator systems, and more particularly to identifying and locating eligible Women, Infants, and Children (“WIC”) items in a store.

### BACKGROUND INFORMATION

The United States Department of Agriculture administers a special supplemental nutrition program for women, infants and children, commonly referred to as “WIC”. The WIC program targets the low-income, nutritionally at risk population. In particular, the WIC program may assist pregnant women, infants up to their first birthday and children up to their fifth birthday. The WIC program provides many benefits to such women, infants and children, such as supplemental nutritious foods, nutrition education and counseling at WIC clinics and screening and referrals to other health, welfare and social services. The WIC program currently serves approximately 3.82 million children, 1.95 million infants and 1.86 million women at a cost of approximately 4.7 billion dollars.

Currently, WIC participants may receive checks or vouchers to purchase specific foods each month that are designed to supplement their diets. The foods provided are high in one or more of the following nutrients: protein, calcium, iron and vitamins A and C. These are the nutrients frequently lacking in the diets of the program's target population. Different food packages are provided for different categories of participants.

The WIC foods in a food package that are available to be purchased by a particular WIC participant may not be easily identified in a grocery store. Some of these WIC items may be identified, such as by a sticker with the label “WIC authorized”. However, these stickers may be not be self evident. For example, the WIC eligible items, along with their WIC eligible labels, may be stocked in high or low positions on a shelf and hence may not be easily identified. Furthermore, not all of the WIC eligible items may be marked.

After the WIC participant placed the eligible WIC items that could be located in the grocery cart, the WIC participant may hand the cashier a paper voucher to purchase the items. There are various problems with using paper vouchers to purchase WIC items. For example, the cashier may assume incorrectly that the items purchased with the voucher were all eligible WIC items. Furthermore, using the paper voucher to purchase WIC items may result in long waits by retailers for reimbursement. Furthermore, the WIC participant may be uncomfortable to hand the cashier a WIC paper voucher due to the stigma associated with receiving food for free from a government program.

Consequently, the U.S. Department of Agriculture in 2002 promulgated a program, referred to as the “Electronic Benefits Transfer (“EBT”) program, designed to replace the time-consuming and error-prone paper voucher system that was costly to administer, often uncomfortable for participants to use, and could result in long waits by retailers for reimbursement. Pilot programs for implementing the EBT program are now occurring across the country.

However, there are no current product locator systems that implement the WIC-EBT standard while also assisting the WIC participant in locating their WIC eligible items in the store.

Therefore, there is a need in the art for a product locator system that implements the WIC-EBT standard while also assisting the WIC participant in locating their WIC eligible items in the store.

### SUMMARY

The problems outlined above may at least in part be solved in some embodiments by having the WIC participant receive a non-volatile memory storage device, e.g., smart card, that stores the WIC participant's personalized food package. A shopping device, which may be attached to a shopping cart, may be configured to either read the non-volatile memory storage device storing the WIC participant's personalized food package or receive the WIC participant's personalized food package from a store controller. The store controller may store the WIC participant's personalized food package by having a point of sale terminal read the non-volatile memory storage device containing the WIC participant's personalized food package and then store the data read on the non-volatile memory storage device on the store controller. The shopping device may display the eligible WIC items in the WIC participant's personalized food package in terms of the layout of the store. The shopping device may also be configured to guide the WIC participant, such as through arrows or word commands displayed on the shopping device or audibly via a speaker on the shopping device, to the eligible WIC items. In this manner, a system that implements the WIC-EBT standard while also assisting the WIC participant in locating their WIC eligible items in the store is provided.

In one embodiment of the present invention, a method for identifying and locating items in a store may comprise the step of reading a non-volatile memory storage device, e.g., smart card, storing information regarding a personalized food package that includes a list of food items available to be purchased by a customer, e.g., Women, Infants and Children (“WIC”) participant. The method may further comprise displaying where items in the personalized food package are located in the store in terms of a layout of the store. The method may further comprise guiding the customer to where the items in the personalized food package are located in the store.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE DRAWINGS

A better understanding of the present invention can be obtained when the following detailed description is considered in conjunction with the following drawings, in which:

FIG. 1 illustrates an embodiment of the present invention of having a shopping device located on a shopping cart;

FIG. 2 illustrates an embodiment of the present invention of a shopping device;

FIG. 3 illustrates an alternative embodiment of the present invention of reading the information stored on the smart card;

FIG. 4 illustrates an embodiment of the present invention of a point of sale terminal; and

FIG. 5 is flowchart of a method for identifying and locating eligible WIC items in a store in accordance with an embodiment of the present invention.

### DETAILED DESCRIPTION

The present invention comprises a method, computer program product and system for identifying and locating eligible WIC items in a store. In one embodiment of the present invention, a shopping device, such as one located on a shopping cart, may obtain a WIC participant's personalized food package that was stored on a non-volatile memory storage device, e.g., smart card, provided to the WIC participant. The shopping device may display the eligible WIC items in the WIC participant's personalized food package in terms of the layout of the store. The shopping device may also be configured to guide the WIC participant, such as through arrows or word commands displayed on the shopping device or audibly via a speaker on the shopping device, to the eligible WIC items. In this manner, a system that implements the WIC-EBT standard while also assisting the WIC participant in locating their WIC eligible items in the store is provided.

Although the present invention is described with reference to the WIC program it is noted that the principles of the present invention may be applied to any government benefit service program. It is further noted that embodiments applying the principles of the present invention to other government benefit service programs would fall within the scope of the present invention.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

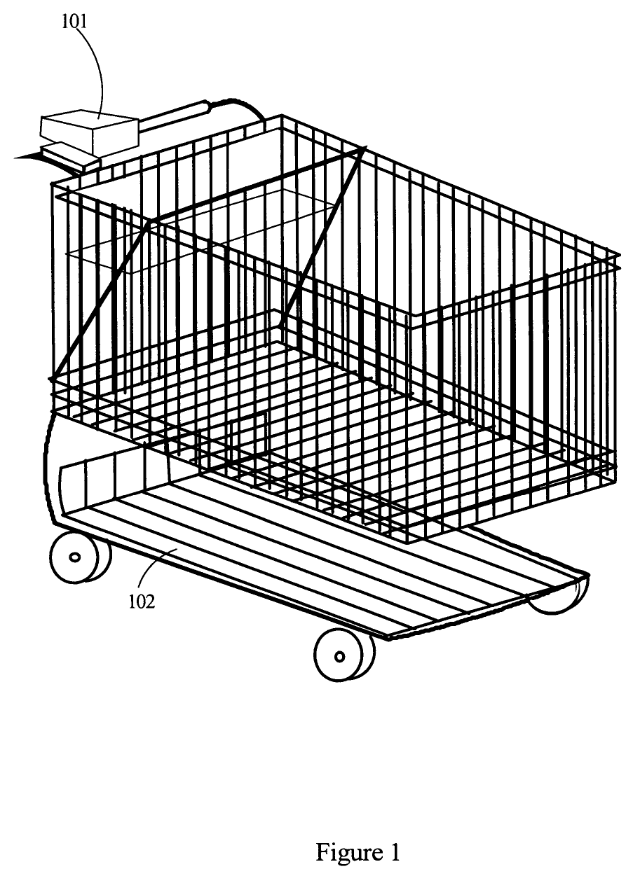

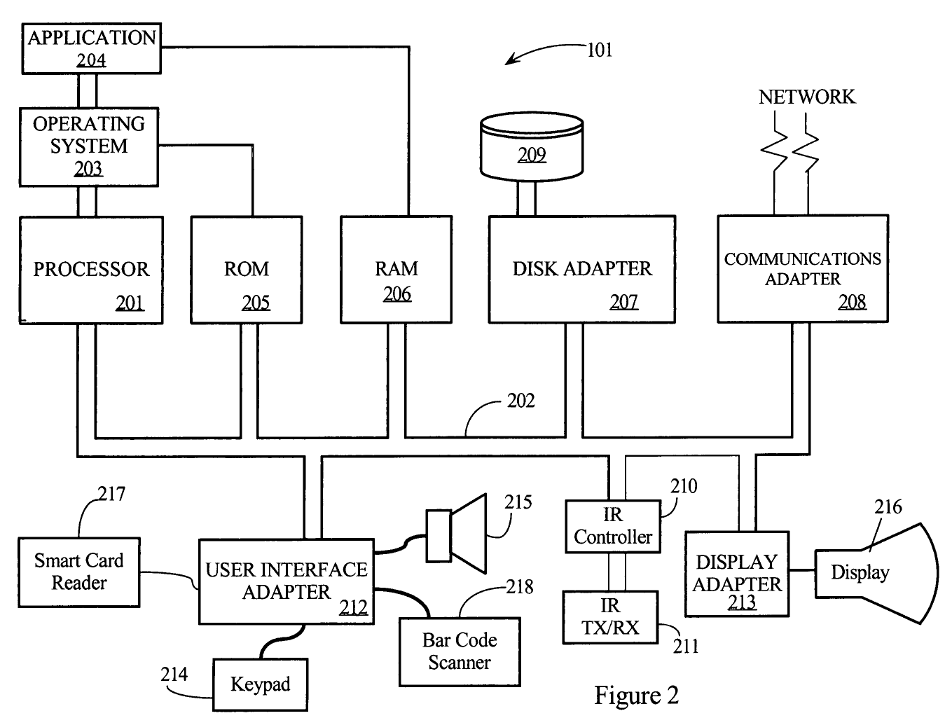

As stated in the Background Information section, the U.S. Department of Agriculture in 2002 promulgated a program, referred to as the “Electronic Benefits Transfer (“EBT”) program, designed to replace the time-consuming and error-prone paper voucher system that was costly to administer, often uncomfortable for participants to use, and could result in long waits by retailers for reimbursement. Pilot programs for implementing the EBT program are now occurring across the country. However, there are no current product locator systems that implement the WIC-EBT standard while also assisting the WIC participant in locating their WIC eligible items in the store. Therefore, there is a need in the art for a product locator system that implements the WIC-EBT standard while also assisting the WIC participant in locating their WIC eligible items in the store. An embodiment of using a shopping device, e.g., Shopping Buddy™, on a shopping cart to implement the WIC-EBT standard while also assisting the WIC participant in locating their WIC eligible items in the store is described below in association with FIGS. 1-2.

FIG. 1—Shopping Device on a Shopping Cart

FIG. 1 illustrates an embodiment of the present invention of using a shopping device 101 on a shopping cart 102 to implement the WIC-EBT standard while also assisting the WIC participant in locating their WIC eligible items in the store. Shopping device 101 may be placed anywhere on shopping cart 102 but for ease of accessibility by the WIC participant, shopping device 101 may be placed on the handle of shopping cart 102. A more detail description of shopping device 101 is provided below in association with FIG. 2.

FIG. 2—Shopping Device

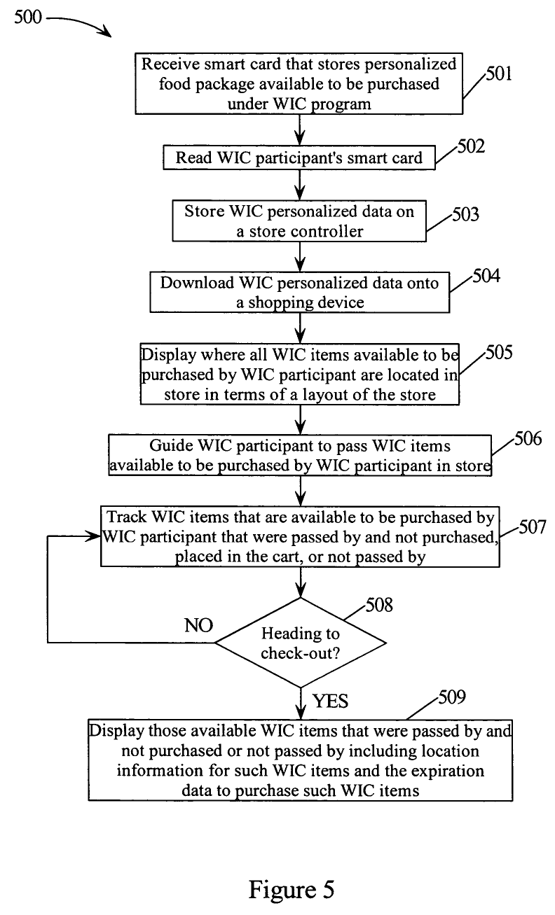

FIG. 2 illustrates an embodiment of the present invention of shopping device 101. Shopping device 101 may comprise a processor 201 coupled to various other components by a bus 202. An operating system 203 may run on processor 201 and provide control as well as coordinate the function of the various components of FIG. 2. An application 204 in accordance with the principles of the present invention may run in conjunction with operating system 203 and provides output calls to operating system 203 where the output calls implement the various functions or services to be performed by application 204. Application 204 may include for example, a program for identifying and locating items in a store as described further below in association with FIG. 5. Application 204 may further include a program for guiding a WIC participant to locate eligible WIC items in the store, such as through arrows or word commands displayed on a display or audibly via a speaker, as described further below in association with FIG. 5. The guidance software may further identify eligible WIC items in terms of the layout of the store as described further below in association with FIG. 5. The guidance software may further alert the WIC participant when the WIC participant is near an eligible WIC item as described further below in association with FIG. 5. For example, the WIC participant may be alerted of being near an eligible WIC item such as by a sound transmitted through a speaker.

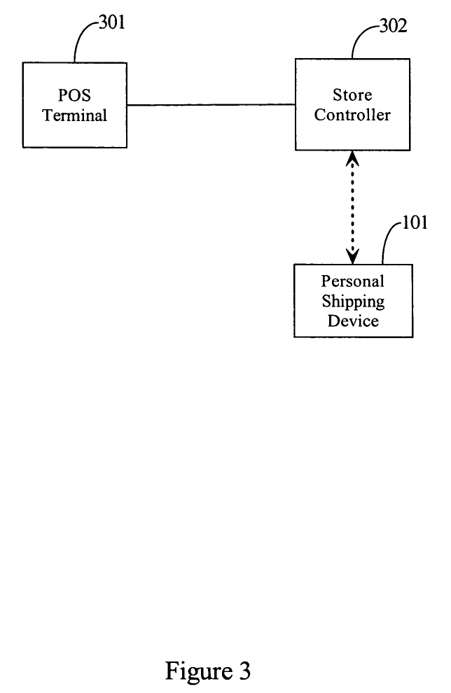

Referring to FIG. 2, read only memory (ROM) 205 may be coupled to bus 202 and include a Basic Input/Output System (“BIOS”) that controls certain basic functions of shopping device 101. Random access memory (RAM) 206, disk adapter 207, and communications adapter 208 may also be coupled to bus 202. It should be noted that software components including operating system 203 and application 204 may be loaded into RAM 206 which may be shopping device's 101 main memory. Disk adapter 207 may be an integrated drive electronics (“IDE”) adapter that communicates with disk unit 209, e.g., disk drive. It is noted that the program of the present invention that identifies and locates items in a store, as described in association with FIG. 5, may reside in disk unit 209 or in application 204. It is further noted that the program of the present invention that guides a WIC participant to locate eligible WIC items in the store, such as through arrows or word commands displayed on a display, as described in association with FIG. 5, may reside in disk unit 209 or in application 204. It is further noted that the program of the present invention that alerts the WIC participant when the WIC participant is near an eligible WIC item, as described in association with FIG. 5, may reside in disk unit 209 or in application 204. Communications adapter 208 may interconnect bus 202 with an outside network enabling shopping device 101 to communicate with a store controller or other similar devices, as discussed below in association with FIG. 3.

Shopping device 101 may further comprise an Infrared (IR) controller 210 coupled to bus 202. IR controller 210 may be a dedicated controller configured for processing an infrared code transmitted/received by an IR transceiver 211 and for capturing the same as data. Subsequently, shopping device 101 may communicate with a store controller (described below) to obtain data, such as a personalized food package for a particular WIC participant, as described further below in association with FIG. 5. These food packages may commonly be referred to as a “customer prescription”. The reference to “personalized food packages” hereinafter has the same meaning as “personalized customer prescription”. Shopping device 101 may further be configured to transmit and receive IR beams to and from beacons strategically placed in a store, e.g., mounted on the ceiling of the store, in order to determinate the location of shopping device 101 in the store. Determining one's location in a store using IR beams is well known in the art and will not be described in detail for the sake of brevity. For example, Cuesol's ShopWatch™ system enables a shopping cart to determine its location in the store via IR beacons mounted to the ceiling of the store.

Input/Output devices may also be connected to bus 202 via a user interface adapter 212 and display adapter 213. A keypad 214 and a speaker 215 may be connected to bus 202 through user interface adapter 212. A display 216 may be connected to bus 202 by display adapter 213. In this manner, a user, such as a WIC participant, may be capable of inputting to shopping device 101 and receiving output from shopping device 101 via display 216.

Shopping device 101 may further include a smart card reader 217 configured to read smart cards. A smart card may refer to a credit card like card with a built-in microprocessor and memory used for identification or financial transactions. It is noted that in other embodiments, different forms of non-volatile memory storage devices such as memory keys, memory sticks, digital photo memory cards and Radio Frequency Identification (RFID), may be used instead of a smart card. It is further noted that shopping device 101 may be configured to include readers of such non-volatile memory storage devices.

When inserted into smart card reader 217, it transfers data to smart card reader 217. As stated above, the U.S. Department of Agriculture promulgated the EBT program to replace the time-consuming and error-prone paper voucher system. The EBT program may be implemented using a smart card that stores a personalized food package that includes a list of WIC food items available to be purchased by a particular WIC participant. The smart card may further contain “digital money” with an expiration date to purchase the items listed in the personalized food package. The WIC participant may be provided with a new smart card on a periodic basis that contains the same or an updated personalized food package to assist that participant.

Shopping device 101 may further include a bar code scanner 218 configured to scan the bar codes located on food items. The WIC participant may scan the bar code of each item placed in the cart in order for shopping device 101 to track the items intended to be purchased.

It is noted that FIG. 2 is illustrative and that shopping device 101 may include other components, e.g., stylus, than discussed above. It is further noted that shopping device 101 is not intended to be limited in scope to the components described above.

Implementations of the invention include implementations as a computer system programmed to execute the method or methods described herein, and as a computer program product. According to the computer system implementation, sets of instructions for executing the method or methods are resident in the random access memory 206 of one or more computer systems configured generally as described above. Until required by shopping device 101, the set of instructions may be stored as a computer program product in another computer memory, for example, in disk drive 209 (which may include a removable memory such as an optical disk or floppy disk for eventual use in the disk drive 209). Further, the computer program product may also be stored at another computer and transmitted when desired to the user's workstation by a network or by an external network such as the Internet. One skilled in the art would appreciate that the physical storage of the sets of instructions physically changes the medium upon which it is stored so that the medium carries computer readable information. The change may be electrical, magnetic, chemical, biological, or some other physical change.

As stated above, shopping device 101 may include smart card reader (element 217) configured to read the smart card that stores the listing of WIC items available to be purchased by a WIC participant. In an alternative embodiment, shopping device 101 may not be configured with a smart card reader. Instead, the WIC participant may go to the customer service desk or other similar area at the store and insert the smart card storing information regarding the WIC participant's personalized food package in a point of sale terminal, as discussed below in association with FIG. 3.

FIG. 3—Alternative Embodiment to Reading Smart Card

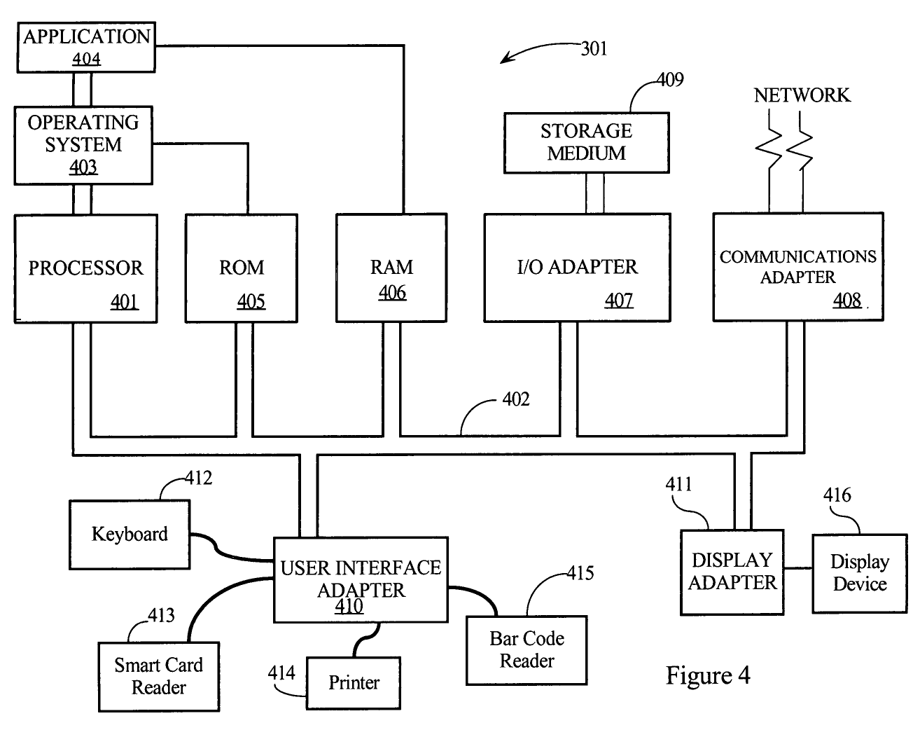

FIG. 3 illustrates an alternative embodiment of the present invention of reading a smart card or other non-volatile memory storage device storing information regarding the WIC participant's personalized food package. Referring to FIG. 3, such an embodiment may include a point of sale terminal 301 configured to include a reader, e.g., smart card reader, to read a non-volatile memory storage device, e.g., smart card. A more detail description of point of sale terminal 301 is provided below in association with FIG. 4.

Referring to FIG. 3, point of sale terminal 301 may transmit the information read form the smart card to a store controller 302. Store controller 302 may be any computer-type device configured to store vast amounts of information. The personalized food package stored on store controller 302 may be retrieved by shopping device 101 used by the appropriate WIC participant (referring to the WIC participant receiving their personalized food package) in any number of means such as through infrared transmission using IR transceiver 211 or via an in-store wireless network. In one embodiment, the appropriate information (appropriate personalized food package) may be downloaded to shopping device 101 by the WIC participant entering the appropriate information, e.g., name, address, in shopping device 101.

FIG. 4—Point of Sale Terminal

FIG. 4 illustrates an embodiment of the present invention of point of sale terminal 301. Point of sale terminal 301 may comprise a processor 401 coupled to various other components by a bus 402. An operating system 403 may run on processor 401 and provide control as well as coordinate the function of the various components of FIG. 4. Application 404 may run in conjunction with operating system 403 which implements the various functions to be performed by application 404. Application 404 may include, for example, a program for transmitting the information read on a smart card, such as a WIC participant's personalized food package, to store controller 302. Application 404 may further include a program for indicating the location of WIC items in terms of the layout of the store.

Point of sale terminal 301 may further comprise a read only memory (ROM) 405 coupled to bus 402 and may include a basic input/output system (“BIOS”) that controls certain basic functions of point of sale terminal 301. Random access memory (RAM) 406, Input/Output (I/O) adapter 407 and communications adapter 408 may also coupled to bus 402. It should be noted that software components including operating system 403 and application 404 may be loaded into RAM 406 which may be point of sale terminal's 301 main memory. I/O adapter 407 may be an integrated drive electronics (“IDE”) adapter that communicates with a storage medium 409, e.g., disk drive. It is noted that the program of the present invention, that transmits the information read on a smart card, such as a WIC participant's personalized food package, to store controller 302, may reside in storage medium 409 or in application 404. It is further noted that the program of the present invention, that indicates the location of WIC items in terms of the layout of the store, may reside in storage medium 409 or in application 404. Communications adapter 408 may interconnect bus 402 with an outside network enabling point of sale terminal 301 to communicate with store controller 302 or other devices via a network.

Point of sale terminal 301 may further comprise Input/Output (I/O) devices that may be coupled to bus 402 via a user interface adapter 410 and a display adapter 411. Keyboard 412, smart card reader 413 (configured similarly to smart card reader 217), printer 414 and bar code reader 415 may all be interconnected to bus 402 through user interface adapter 410. Smart card reader 413 may be used for reading a smart card storing information regarding the WIC participant's personalized food package. It is noted that in other embodiments, different forms of non-volatile memory storage devices such as memory keys, memory sticks, digital photo memory cards and Radio Frequency Identification (RFID), may be used instead of a smart card. It is further noted that point of sale terminal 301 may be configured to include readers of such non-volatile memory storage devices. Printer 414 may be used for printing receipts, coupons and vouchers as directed by processor 301. In one embodiment, point of sale terminal 301 may be configured to read the smart card storing information regarding the WIC participant's personalized food package using smart card reader 413. The eligible WIC items in the WIC participant's personalized food package may be printed out via printer 414 thereby allowing the WIC participant to know which WIC items the WIC participant is eligible to purchase. In one embodiment, the print-out may further contain the location of the available WIC items to be purchased in terms of the layout of the store. Bar code reader 415 may be used for scanning information on bar codes such as on coupons as well as reading information on a customer identification card. A display device 416 may be coupled to bus 402 through display adapter 411. Display device 416 may be used for displaying alphanumeric characters, e.g., listing of the items purchased along with the purchase price of each item, to the cashier and/or customer. In this manner, a user may be capable of inputting to point of sale terminal 301 through keyboard 412, smart card reader 413, bar code reader 415 and receiving output from point of sale terminal 301 via printer 414 or display device 416. It is noted that there are numerous types of input devices, printers and display devices known to those skilled in the art and thus need not be described in detail herein.

Implementations of the invention include implementations as a point of sale terminal programmed to execute the method or methods described herein, and as a computer program product. According to the point of sale terminal implementation, sets of instructions for executing the method or methods may be resident in the random access memory 406 of one or more point of sale terminal systems configured generally as described above. Until required by point of sale terminal 301, the set of instructions may be stored as a computer program product in another memory, for example, in storage medium 409 (which may include a removable memory such as an optical disk or floppy disk for eventual use in the storage medium 409). Further, the computer program product may also be stored at another point of sale terminal and transmitted when desired to the user's workstation by a network or by an external network such as the Internet. One skilled in the art would appreciate that the physical storage of the sets of instructions physically changes the medium upon which it is stored so that the medium carries computer readable information. The change may be electrical, magnetic, chemical, biological or some other physical change.

As stated above, shopping device 101 (FIGS. 1 and 2), and in some embodiments, point of sale terminal 301 (FIGS. 3 and 4) in additional to shopping device 101, may be used to implement the WIC-EBT program while also assisting the WIC participant in locating their WIC eligible items in the store using the method described in FIG. 5. FIG. 5 is a flowchart of a method for identifying and locating eligible WIC items in a store.

FIG. 5—Method for Identifying and Locating Eligible WIC Items in a Store

FIG. 5 is a flowchart of an embodiment of the present invention of a method 500 for identifying and locating eligible WIC items in a personalized food package for a WIC participant in a store.

Referring to FIG. 5, in conjunction with FIGS. 1-4, in step 501, point of sale terminal 301, or alternatively, shopping device 101, receives a smart card from a WIC participant storing their personalized food package.

In step 502, smart card reader 413, or alternatively, smart card reader 217, reads the information stored on the smart card including information regarding a personalized food package that includes a list of food items available to be purchased by the WIC participant.

In the embodiment of using smart card reader 413 in point of sale terminal 301, method 500 includes steps 503 and 504. In the alternative embodiment of using smart card reader 217 in shopping device 101, method 500 proceeds to step 505 from step 502.

Referring to FIG. 5, in step 503, point of sale terminal 301 stores the information read by smart card reader 413 in store controller 302. In step 504, shopping device 101 downloads the appropriate WIC personalized food package from store controller 302. In one embodiment, the appropriate information (appropriate personalized food package) may be downloaded to shopping device 101 by the WIC participant entering the appropriate information, e.g., name, address, in shopping device 101.

In step 505, shopping device 101 displays where all WIC items available to be purchased by the WIC participant are located in the store. In one embodiment, these eligible WIC items may be shown in terms of a layout of the store.

In step 506, shopping device 101 guides the WIC participant to pass the eligible WIC items in their personalized food package in the store. In one embodiment, shopping device 101 may guide the WIC participant using arrows, e.g., left and right arrows, and word commands displayed on display 216 directing the WIC participant to proceed to the appropriate aisle and shelf. For example, shopping device 101 may display commands on display 216 that directs the WIC participant to the appropriate shelf and how far down the aisle the WIC item is located. In one embodiment, the guidance software in shopping device 101 may alert the WIC participant when the WIC participant is near an eligible WIC item. The WIC participant may be alerted of being near an eligible WIC item such as by a sound transmitted through speaker 215 or via a notification on display 216 on shopping device 101.

In step 507, shopping device 101 tracks the eligible WIC items in the personalized food package that was placed in the shopping cart, passed by and not purchased or not passed by as the WIC participant shops throughout the store. In one embodiment, shopping device 101 tracks the eligible WIC items placed in the shopping cart by the WIC participant scanning the bar code on the WIC item placed in the shopping cart using bar code scanner 218. In one embodiment, shopping device 101 tracks those eligible WIC items passed by and not purchased as well as those eligible WIC items not passed by using the guidance software that determines the location of the WIC participant in the store using the IR beacons placed in the store.

In step 508, shopping device 101 determines whether the WIC participant is heading towards the check-out lane in the store. In one embodiment, shopping device 101 determines whether the WIC participant is heading towards the check-out lane in the store using the guidance software in shopping device 101 that determines the location of the WIC participant in the store in terms of the layout of the store. In an alternative embodiment, the WIC participant may indicate to shopping device 101 that they are finished shopping by hitting a button on keypad 214.

If the WIC participant is not heading towards the check-out lane of the store, shopping device 101 continues to track the eligible WIC items in the personalized food package that was placed in the shopping cart, passed by and not purchased or not passed by in step 507. If, however, the WIC participant is heading towards the check-out lane, then, in step 509, shopping device 101 displays on display 216 those available WIC items that were passed by and not purchased as well as those items not passed by. In one embodiment, shopping device 101 may further display on display 216 the location information for those items displayed. In one embodiment, shopping device 101 may further display on display 216 the expiration date to purchase the WIC eligible items displayed.

It is noted that method 500 may include other and/or additional steps that, for clarity, are not depicted. It is further noted that method 500 may be executed in a different order presented and that the order presented in the discussion of FIG. 5 is illustrative. It is further noted that certain steps in method 500 may be executed in a substantially simultaneous manner. It is further noted that shopping device 101 or point of sale terminal 301 may receive any type of non-volatile memory storage device in step 501 and be configured with a reader to read such a device.

Although the system, method and computer program product are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

1. A method for identifying and locating items in a store comprising the steps of:
reading a non-volatile memory storage device storing information regarding a personalized food package that includes a list of food items available to be purchased by a customer;
displaying where items in said personalized food package are located in said store in terms of a layout of said store; and
guiding said customer to where said items in said personalized food package are located in said store.

2. The method as recited in claim 1 further comprising the step of:
tracking which of said items in said personalized food package were passed by and not purchased.

3. The method as recited in claim 2 further comprising the step of:
displaying location information of said items in said personalized food package that were passed by and not purchased.

4. The method as recited in claim 3 further comprising the step of:
displaying an expiration date to purchase said items in said personalized food package that were passed by and not purchased.

5. The method as recited in claim 1 further comprising the step of:
tracking which of said items in said personalized food package were not passed by.

6. The method as recited in claim 5 further comprising the step of:
displaying location information of said items in said personalized food package that were not passed by.

7. The method as recited in claim 6 further comprising the step of:
displaying an expiration date to purchase said items in said personalized food package that were not passed by.

8. The method as recited in claim 1 further comprising the step of:
tracking which of said items in said personalized food package were placed in a cart.

9. The method as recited in claim 1, wherein said customer is a Women, Infants and Children (“WIC”) participant.

10. A computer program product embodied in a machine readable medium for identifying and locating items in a store comprising the programming steps of:
reading a non-volatile memory storage device storing information regarding a personalized food package that includes a list of food items available to be purchased by a customer;
displaying where items in said personalized food package are located in said store in terms of a layout of said store; and
guiding said customer to where said items in said personalized food package are located in said store.

11. The computer program product as recited in claim 10 further comprising the programming steps of:
tracking which of said items in said personalized food package were passed by and not purchased;
tracking which of said items in said personalized food package were not passed by; and
tracking which of said items in said personalized food package were placed in a cart.

12. The computer program product as recited in claim 10, wherein said customer is a Women, Infants and Children (“WIC”) participant.

13. A system, comprising:
a point of sale terminal configured to read a non-volatile memory storage device storing information regarding a personalized food package that includes a list of food items available to be purchased by a customer;
a store controller coupled to said point of sale terminal, wherein said store controller is configured to store said information read on said non-volatile memory storage device; and
a shopping device coupled to said store controller, wherein said shopping device is configured to download data of said personalized food package of said customer, wherein said shopping device comprises:
a memory unit operable for storing a computer program for identifying and locating items in a store; and
a processor coupled to said memory unit, wherein said processor, responsive to said computer program, comprises:
circuitry for displaying where items in said personalized food package are located in said store in terms of a layout of said store; and
circuitry for guiding said customer to where said items in said personalized food package are located in said store.

14. The system as recited in claim 13, wherein said shopping device further comprises:
an infrared transceiver coupled to said processor, wherein said infrared transceiver is configured to receive data of said personalized food package data of said customer from said store controller.

15. The system as recited in claim 13, wherein said shopping device further comprises:
a bar code scanner coupled to said processor, wherein said bar code scanner is configured to scan items in said personalized food package placed in a cart.

16. The system as recited in claim 13, wherein said shopping device further comprises:
an infrared transceiver coupled to said processor, wherein said infrared transceiver is configured to send and receive infrared signals used to determine a location in said store.

17. The system as recited in claim 13, wherein said customer is a Women, Infants and Children (“WIC”) participant.

18. A system, comprising:
a reader configured to read information stored on a non-volatile memory storage device;
a memory unit operable for storing a computer program for identifying and locating items in a store; and
a processor coupled to said memory unit and to said reader, wherein said processor, responsive to said computer program, comprises:
circuitry for reading said non-volatile memory storage device storing information regarding a personalized food package that includes a list of food items available to be purchased by a customer;
circuitry for displaying where items in said personalized food package are located in said store in terms of a layout of said store; and
circuitry for guiding said customer to where said items in said personalized food package are located in said store.

19. The system as recited in claim 18 further comprising:
a bar code scanner coupled to said processor, wherein said bar code scanner is configured to scan items in said personalized food package placed in a cart.

20. The system as recited in claim 18 further comprising:
an infrared transceiver coupled to said processor, wherein said infrared transceiver is configured to send and receive infrared signals used to determine a location in said store.

21. The system as recited in claim 18, wherein said processor further comprises:
circuitry for tracking which of said items in said personalized food package were passed by and not purchased;
circuitry for tracking which of said items in said personalized food package were not passed by; and
circuitry for tracking which of said items in said personalized food package were placed in a cart.

22. The system as recited in claim 18, wherein said customer is a Women, Infants and Children (“WIC”) participant.
